(19) United States
(12) Patent Application Publication
(10) Pub. No.: US 2021/0173826 A1
(43) Pub. Date: Jun. 10, 2021

(54) SYSTEM AND METHODS FOR SECURING SOFTWARE CHAIN OF CUSTODY

(71) Applicant: Vivsoft Technologies LLC, Brambleton, VA (US)

(72) Inventors: Tapasvi KAZA, Reston, VA (US); Navin GUNALAN, Brambleton, VA (US)

(73) Assignee: Vivsoft Technologies LLC, Brambleton, VA (US)

(21) Appl. No.: 17/114,064

(22) Filed: Dec. 7, 2020

Related U.S. Application Data
(60) Provisional application No. 62/944,112, filed on Dec. 5, 2019.

(51) Int. Cl. G06F 16/23; H04L 9/06

(52) U.S. Cl. CPC G06F 16/2365; H04L 2209/38; H04L 9/0637

(57) ABSTRACT

Systems and methods to securing software chain-of-custody for Continuous Integration (CI)/Continuous Delivery (CD) based automated software release and deployments using blockchain technology. Metadata from each stage of the CI/CD pipeline is used to capture the provenance of the software artifacts along with the metadata of the context in which it was generated to secure the chain-of-custody and prevent the deployment of malicious software.

### CROSS-REFERENCE TO RELATED APPLICATIONS

This application is a continuation of U.S. Provisional Application No. 62/944,112, filed Dec. 5, 2019 in the U.S. Patent and Trademark Office. All disclosures of the document named above are incorporated herein by reference.

### BACKGROUND OF THE INVENTION

### 1. Field of the Invention

At least some embodiments disclosed herein relates to securing a software chain of custody, and more particularly, but not limited to, securing the software chain-of-custody for a Continuous Integration (CI)/Continuous Delivery (CD) based automated software release and deployments. The software chain-of-custody system is implemented using blockchain encryption technology. By way of one general example, aspects of the present invention track and record the chain-of-custody for software within a Continuous Integration (CI)/Continuous Delivery (CD) pipeline and creates a non-repudiatable and immutable encrypted block that records the metadata from each stage of the software automation process.

### 2. Description of Related Art

The process to build and release software is getting more automated by the day with the use of CI/CD based automated pipelines. In every enterprise, there are multiple teams using automated pipelines to build and deliver software. Typically, an automated pipeline to generate software will contain multiple tools which check the integrity of the software by running security checks against the software. As the number of pipelines grow, along with the growing number of tools within each pipeline, the total number of software artifacts that need to be tracked for provenance will also grows dramatically.

The prior approach for securing software chain-of-custody involves the manual or script-based collection and storing of ownership information for software artifacts from different team members. This approach involves the manual querying and updating of software metadata to generate a chain of custody. The manual creation and storing of chain-of-custody is unsafe because it can be altered and modified. Also, this process is inherently error-prone and also requires a significant amount of time and manual resources and will not scale to support the automated build and release of software.

While there is substantial prior art on the use and application of blockchain encryption technology, most of the known prior art uses the blockchain technique merely to encrypt and decrypt documents. For example, seminal U.S. Pat. No. 4,309,569, for Method of Providing Digital Signatures by Merkle, teaches a method of providing a digital signature for purposes of authenticating a message, using an authentication tree function of a one-way function of a secret number. Nothing in Merkle shows a particular application of the technology disclosed and shows no application to software chain-of-custody integrity.

Similarly, U.S. Pat. No. 8,744,076, for a Method and Apparatus for Encrypting Data to Facilitate Resource Savings and Tamper Detection by Youn, discloses a method for generally preventing the tampering of encrypted data. The '076 patent more specifically focuses on the particular encryption technology used, and not on the application of such technology to prevent tampering of software artifacts that are built using automation.

A different disclosure relating to chain-of-custody security is Patent Cooperation Treaty application PCT/US2016/046446 (WO 2017027648A1) for a System and Methods to Ensure Asset and Supply Chain Integrity, by Mattev, et al. While the '446 application addresses the Asset and Supply Chain Integrity of physical objects, it does not address the security of software artifacts, nor does it address the method in which CI/CD automation collects contextual data from different sources (such as software commit information, developer identity, automated test results, policy applied to the software and the lineage of the artifacts) to create blocks in a blockchain to provide provenance and chain of custody for the software artifacts.

### SUMMARY OF THE INVENTION

Therefore, what is needed are techniques that overcome the above-mentioned gaps and disadvantages. Specifically, aspects of this invention address the gaps in several of the above-mentioned chain of custody systems and methods to secure software chain-of-custody for software artifacts generated using a Continuous Integration (CI)/Continuous Delivery (CD) based automated software release and deployments as described herein. Some embodiments are summarized in this section. The teachings disclosed extend to those embodiments which fall within the scope of the appended claims, regardless of whether they accomplish one or more of the needs mentioned above.

### Chain-of-Custody Software Summary

In various embodiments, chain-of-custody software is provided. A chain-of-custody is a security tool that provides contextual data into the actions by owners of software artifacts at each stage of the software lifecycle that results in the creation of the software. The contextual metadata may include the identity of the developers of the software and the automation tools that result in the generation, deployment and configuration of complex software. The chain-of-custody software pipeline accomplishes this by providing a blockchain transaction client software that collects information from each stage of a software build and creates an immutable record in an encrypted ledger.

In one embodiment of the disclosed invention is a methodology for ensuring security of a software artifact in a CI/CD pipeline. A method that adds key verification and validation mechanisms capture the results from a CI/CD via the use of blockchain technology is discussed. This methodology treats each individual stage of a CI or CD as a node in the automated software lifecycle. The results generated through the automated build and verification of software artifacts are grouped into blocks in a blockchain. This creates an encrypted record of the outcome of various stages in the automated pipeline and using multiple blockchains to record and maintain software chain-of-custody information, said methodology comprising the steps of:

installing a blockchain transaction client in the automated CI/CD pipeline stages to capture the results and contextual metadata within that stage;

collecting software commit identity information for the source repository;

collecting software build information from an automation orchestrator;

collecting the result of a static code analysis; (e) collecting the result of the security tests conducted to validate the that the software artifacts do not contain any malicious code or vulnerability;

collecting the result of functional tests that validate the functionality of the software being developed;

transmitting the metadata from the CI/CD stage using the client to the blockchain network; and

generating an immutable, encrypted and non-repudiatable block for the received metadata based on the consensus within the blockchain network.

In one embodiment of the disclosed invention is a methodology for tracking contextual metadata of a software being deployed into a production environment.

This information includes the provenance of the software from the developer of the code all the way to the policies that the software must pass in order to run in the production cluster.

The contextual metadata captured in the blockchain is also stored in a database called a “world state”.

By creating a ledger to capture metadata from each state (CI/CD/Policy etc.) of the pipeline, the chain of custody for each category of artifact within automated pipeline can be tracked independently.

The ledger can be queried and linked to build a temporal, holistic view of who chain-of-custody for the generated and deployed artifact.

Additionally, the results of each stage of the pipeline provide chain of custody for the artifact can be linked with other contextual data to provide a view into what policies were applied to the artifact before it is allowed to run in a production environment.

### BRIEF DESCRIPTION OF THE DRAWINGS

These and/or other aspects and advantages of the invention will become apparent and more readily appreciated from the following description of embodiment taken in conjunction with the accompanying drawings. The present invention is illustrated by way of example and not limitation in the figures of the accompanying drawings in which like references indicate similar elements.

FIG. 1 illustrates a schematic overview of a CI/CD pipeline that represents an automated methodology for building software according to one embodiment.

FIG. 2 illustrates a design approach to record the metadata related to each action within an CI/CD pipeline as a block in the leger according to one embodiment.

FIG. 3 shows a schematic approach related to recording the metadata from a CI/CD pipeline as a block in a ledger once consensus has been reached within a group of peers according to one embodiment.

FIG. 4 shows the metadata related to one specific action within an CI/CD pipeline that will be recorded as a block in a ledger according to one embodiment.

FIG. 5 shows a schematic of various components of the CI/CD pipeline tools and the blockchain running on servers according to one embodiment.

### DESCRIPTION OF THE EMBODIMENTS

Reference will now be made in detail to the present embodiments of the present invention, examples of which are illustrated in the accompanying drawings, wherein like reference numbers refer to the like elements throughout. The embodiments are described below in order to explain the present invention by referring to the figures. The following description and drawing are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not all necessarily refer to the same embodiment.

It should be noted that any language directed to a CI/CD pipeline stage or tool should be read to include but not limited to any individual, or suitable combination of testing, build or deployment automation tools or parts that operate individually or collectively, and that may exchange data with other tools or systems.

One should appreciate that the disclosed method(s) herein refer to blockchain technologies as a whole, which include various implementations of blockchain, blockDAGs (Distributed Acyclic Graphs), ledgers, hyperledgers, distributed ledgers and related distributed database management and dissemination technologies. Distributed ledger systems described herein can be permissioned or permissionless, private or public, and may involve heterogenous nodes that act as groups, pools or consortiums that own a significant portion of the software build, test or deployment automation.

The following discussion provides example embodiments referring to the inventive subject matter. Other minor variations including semi-automated chain-of-custom deployment are also considered to be included, even if not explicit disclosed. The disclosed system and methodologies have ready application to tracking the chain of custody of software artifacts generated within a CI/CD pipeline to create a blockchain based custody chain showing the generation of each artifact and the metadata capturing the context in which it was generated. FIG. 1 illustrates an overview of the various elements and components relevant to a CI/CD pipeline. In the current example, the pipeline stages 101-106 illustrate the CI stages of a software artifact build lifecycle. 106-108 depict the CD stages of a software artifact deployment lifecycle. 109 shows the blockchain transaction client that is used to capture the metadata from the CI/CD stages to transmit the information to the blockchain for verification and processing. Once a developer commits code into a source control system, 101 capture the metadata relevant to the user and the repository information for the submitted code. In 102, a static code analysis tool is executed against the code repository order to find out any possible defect in the code. The results of this stage are then captured and if the committed code passes the tests, it is moved to the build stage of the pipeline, 103. The built code is then tested for functional compliance in 104 using automated functional testing tools like Selenium. Once the functionality is confirmed, the software artifact is tested for security in 105 and only the artifacts that pass the security tests are stored in an artifact repository such as Artifactory. To secure the ownership of these built artifacts, content trust is enabled in 106 to track the various handoffs that happened in the CI stages of the artifact.

107 is the CD stage of the pipeline which capture the deployment configuration for the generated software artifact. This deployment configuration defines where and how the artifact will be run in the production environment. 108 provides the metadata for the production cluster in which the application is deployed. This completes the lifecycle of an artifact from the build stage to the deployment stage. As newer versions of the software are deployed using automation, the pipeline stages capture the metadata and test results to provide chain-of-custody for the changes in the code base that result in the newer version of software being deployed to production. In some scenarios, manual intervention might be required to validate or troubleshoot an issue, but these changes are also capture using configuration management and identity management elements of the pipeline. 109 is the blockchain transaction client software the exists in each stage of the CI/CD pipeline and transmits the metadata from that stage to the blockchain network for processing.

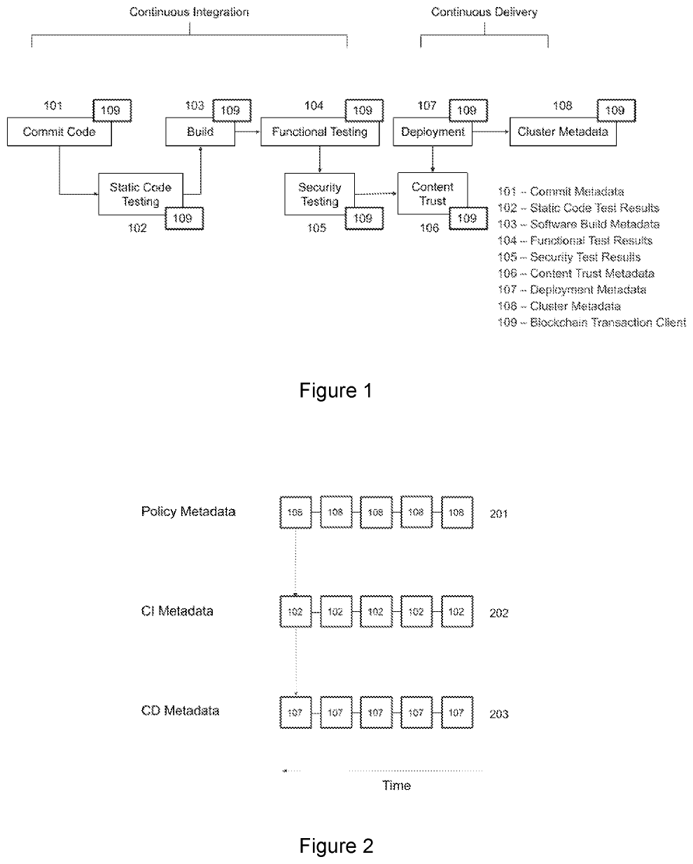

FIG. 2 shows the top-level overview of the design where the metadata from the different stages of the CI/CD pipeline can be captured in a blockchain. For example, 202 shows a blockchain that capture the information from the CI stages 101-106. The ability to capture the metadata from the CI/CD or Cluster stages in a blockchains allows the design to restrict access or build custom consensus mechanisms that relate to the handoffs between the tools within one stage of lifecycle tools. The metadata captured from the tools can be linked based on common metadata as depicted in the arrows in 201-202 to enable linked reporting at the visualization layer of the chain-of-custody.

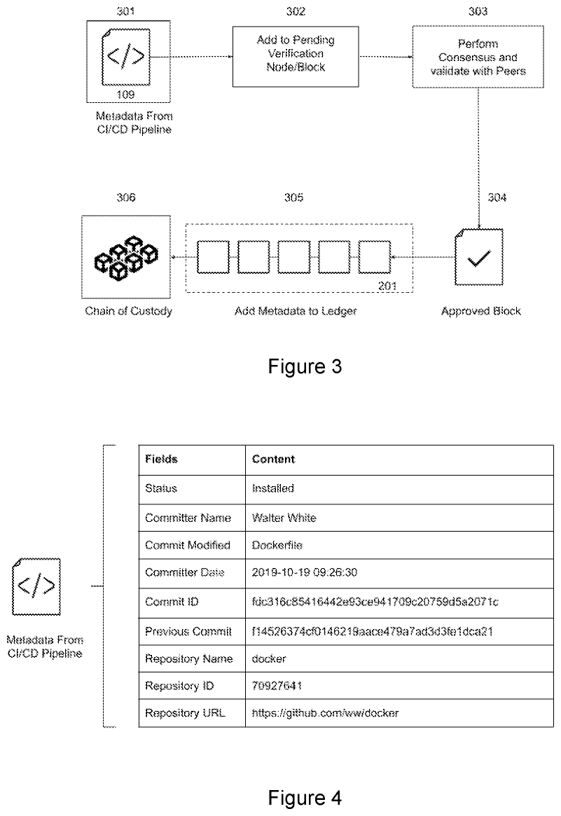

FIG. 3 shows a procedure used to create a non-repudiatable and immutable encrypted block that records the metadata from each stage of the software automation process. The process being when there is a new software lifecycle action that takes place in the CI/CD pipeline. 109 in FIG. 1 is the blockchain transaction client that captures the metadata and transmits it to the nodes in the blockchain. 301 showcases the transmitted metadata from 109 that comprising identity and/or artifact test results that need to be added to the blockchain pending verification as shown in 302. The nodes within the blockchain network perform consensus 303 to validate the metadata with peers if required. Given that the peers in the network might use codified automated policies to validate the results, the consensus mechanism can be driven entirely through automation. Once the information passes the approval process 304, the metadata is packaged into a block and added to the corresponding ledger as showcased in 305. The ledger to which the block is added might depend on the implementation 201. The chain-of-custody for the generated and deployed software artifacts is captured in the blockchains and is queried based on the requirements to provide a timeline based view of the ownership and handoff checks that were passed.

FIG. 4 describes specifically how the CI/CD generated metadata introduced in 301 may assemble transactions that are to be validated. In this example, the metadata comprising identity metadata for the committer as well as specific information regarding the software artifact that was being checked in to the source control repository to be packaged and tested in the automated pipeline prior to deployment. The metadata information from each stage of the CI/CD pipeline will have a unique set of fields that will be transmitted by the blockchain client 109 to the node 301. The transmission mechanism in one embodiment refers to any means of transmission between the blockchain client and the node 301. Other variations of transmission including any combination of communication mechanisms are also considered to be included, even if not explicit disclosed. This metadata will be processed based on the validation logic to create a block once approved as shown in 305. The created blocks will then be available for querying to track the chain-of-custody for the different stages of the CI/CD pipeline.

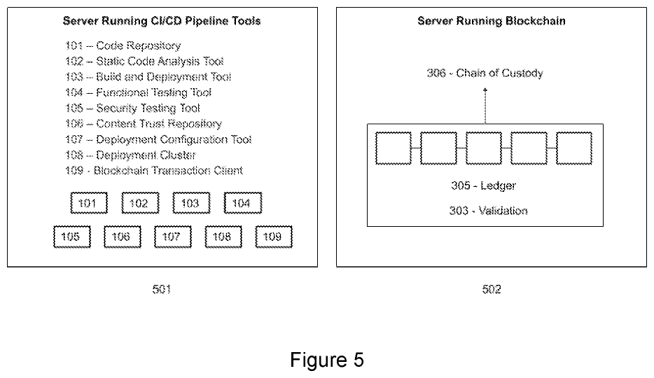

FIG. 5 shows the schematic of the ci/cd pipeline components running on one server 501. The second server 502 shows the blockchain running on a physical server. other variations including running one or more components of the ci/cd pipeline or blockchain on one or more servers or on cloud based infrastructure are also considered to be included, even if not explicit disclosed. Each server comprising a non-transitory computer-readable storage medium storing thereon instructions that, when executed by one or more processors of the apparatus, cause the one or more processors to execute operations as described herein.

Although a few embodiments of the present invention have been shown and described, it would be appreciated by those skilled in the art that changes may be made in this embodiment without departing from the principles and spirit of the invention, the scope of which is defined in the claims and their equivalents.

We claim:

1. A method comprising:
creating, by at least one automated CI/CD pipeline, at least one blockchain ledger to capture the metadata from the different stages of the CI/CD pipeline; and
generating, a chain-of-custody for the software artifacts based on the metadata from the CI/CD pipeline.

2. The method of claim 1, further comprising a blockchain transaction client that is used to capture and initiate a transaction with the metadata from the CI/CD stage, wherein the metadata comprises identity information, results from the tests performed on the created software artifacts or the deployment context related to the running of the created software artifact.

3. The method of claim 2, wherein the metadata transmitted using the blockchain transaction client installed in a CI/CD pipeline stage is validated by the consensus mechanism of a blockchain to determine if the metadata presents a validated dataset that can be added to the blockchain.

4. The method of claim 3, wherein at least one blockchain ledger is created to build an immutable and non-repudiatable encrypted block.

5. The method of claim 4, where the blockchain ledger can be queried to provide chain-of-custody and provenance data for the software artifact that has been built or deployed using a CI/CD pipeline.

6. The method of claim 1, wherein the blockchain is generated by a server, and wherein the blockchain is a chain-of-custody.

7. A system comprising:
at least one processor; and
memory storing instructions configured to instruct the at least one processor to:
create at least one blockchain; and
generate a chain-of-custody for the software artifacts based on at least one blockchain.

8. The system of claim 7, wherein at least one blockchain comprises blockchain components, and wherein the instructions are further configured to instruct at least one processor to initiate the blockchain components to provide a software chain-of-custody.

9. The system of claim 7, wherein the blockchain based chain-of-custody further links to at least one CI/CD pipeline located on one or more remote computing devices, and wherein the remote computing devices.

10. The system of claim 9, wherein at least one blockchain comprises a blockchain client and which links to at least one CI/CD pipeline and sends out metadata related to the pipeline stages using remote calls.

11. A non-transitory computer-storage medium storing instructions configured to instruct at least one computing device to:
create at least one blockchain; and
generate a chain-of-custody for the software artifacts based on at least one blockchain.

12. The non-transitory computer-storage medium of claim 11, wherein the blockchain is configured using declarative configuration files.
